(19) United States
(12) Patent Application Publication
(10) Pub. No.: US 2025/0042272 A1
(43) Pub. Date: Feb. 6, 2025

(54) CHARGING SYSTEM

(71) Applicant: SUBARU CORPORATION, Tokyo (JP)

(72) Inventor: Iyo HASHIMOTO, Tokyo (JP)

(73) Assignee: SUBARU CORPORATION, Tokyo (JP)

(21) Appl. No.: 18/595,722

(22) Filed: Mar. 5, 2024

(30) Foreign Application Priority Data
Mar. 31, 2023 (JP) 2023-057000

(51) Int. Cl. B60L 53/122; B60L 53/66; B60L 53/68; G01C 21/34

(52) U.S. Cl. CPC B60L 53/122; B60L 53/66; B60L 53/68; G01C 21/3469; B60L 2240/667; B60L 2240/68

(57) ABSTRACT

A charging system includes a vehicle and a server. The vehicle includes a battery that is charged in a contactless manner from a power transmission device. The server communicates with the vehicle. The charging system includes an information acquirer configured to acquire information on a destination, a transit point, and a stay time at the transit point of the vehicle; an electric power amount calculator configured to calculate an electric power amount for the vehicle to arrive at the destination; a charge amount calculator configured to calculate a charge amount with which the battery is chargeable at the transit point; an entry determiner configured to determine whether entry into a charging lane in which the power transmission device is installed is possible, based on the electric power amount and the charge amount; and a navigator configured to navigate the vehicle to the charging lane when the entry is possible.

### CROSS-REFERENCE TO RELATED APPLICATION

The present application claims priority from Japanese Patent Application No. 2023-057000 filed on Mar. 31, 2023, the entire contents of which are hereby incorporated by reference.

### BACKGROUND

The present disclosure relates to the technical field of charging systems.

In the related art, a technology has been proposed in which a charging lane is provided in a part of a road, and a battery of a vehicle traveling in the charging lane is charged in a contactless manner (for example, refer to Japanese Unexamined Patent Application Publication No. 2021-128571).

### SUMMARY

An aspect of the disclosure provides a charging system including a vehicle and a server. The vehicle includes a battery that is configured to be charged in a contactless manner from a power transmission device installed in a road. The server is configured to communicate with the vehicle. The charging system includes an information acquirer, an electric power amount calculator, a charge amount calculator, an entry determiner, and a navigator. The information acquirer is configured to acquire information on a destination, a transit point, and a stay time at the transit point of the vehicle. The electric power amount calculator is configured to calculate an electric power amount for the vehicle to arrive at the destination. The charge amount calculator is configured to calculate a charge amount with which the battery is chargeable at the transit point, based on facility information of the transit point. The entry determiner is configured to determine whether entry into a charging lane in which the power transmission device is installed is possible, based on the electric power amount and the charge amount. The navigator is configured to navigate the vehicle to enter the charging lane when the entry determiner determines that the entry into the charging lane is possible.

An aspect of the disclosure provides a charging system including a vehicle and a server. The vehicle includes a battery that is configured to be charged in a contactless manner from a power transmission device installed in a road. The server is configured to communicate with the vehicle. The charging system includes circuitry configured to: acquire information on a destination, a transit point, and a stay time at the transit point of the vehicle; calculate an electric power amount for the vehicle to arrive at the destination; calculate a charge amount with which the battery is chargeable at the transit point, based on facility information of the transit point; determine whether entry into a charging lane in which the power transmission device is installed is possible, based on the electric power amount and the charge amount; and navigate the vehicle to enter the charging lane when the entry into the charging lane is determined to be possible.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram illustrating a general configuration of a charging system;

FIG. 2 is a diagram illustrating a configuration of a vehicle;

FIG. 3 is a diagram illustrating a configuration of a navigation device;

FIG. 4 is a diagram illustrating a configuration of a server;

FIG. 5 is a diagram illustrating an example of a road on which the vehicle travels;

FIG. 6 is a sequence chart illustrating a flow of a charging lane navigation process in the charging system;

FIG. 7 is a diagram illustrating an input screen for a destination, a transit point, and a stay time;

FIG. 8 is a diagram illustrating a navigation screen;

FIG. 9 is a diagram illustrating a charging lane entry navigation screen; and

FIG. 10 is a diagram illustrating a normal lane travel navigation screen.

### DETAILED DESCRIPTION

When a large number of vehicles enter the charging lane, there is a possibility that the charging lane is congested. In addition, there is a possibility that a vehicle having a small charge amount of the battery or a vehicle having an insufficient charge amount to arrive at the destination is unable to enter the charging lane.

It is desirable to navigate, to the charging lane, a vehicle that is likely to be charged while resolving congestion in the charging lane.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

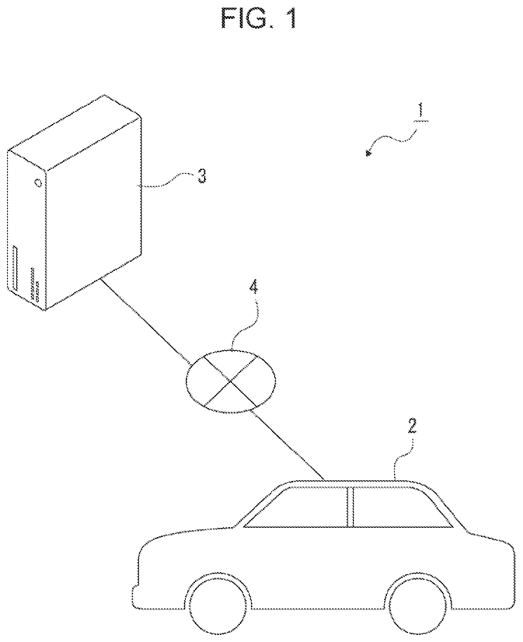

FIG. 1 is a diagram illustrating a general configuration of a charging system 1. As illustrated in FIG. 1, the charging system 1 includes a vehicle 2 and a server 3.

For example, the vehicle 2 is connected to a network 4 such as the Internet in a wireless manner. The server 3 is connected to the network 4 in a wired or wireless manner. The vehicle 2 and the server 3 can communicate with each other via the network 4.

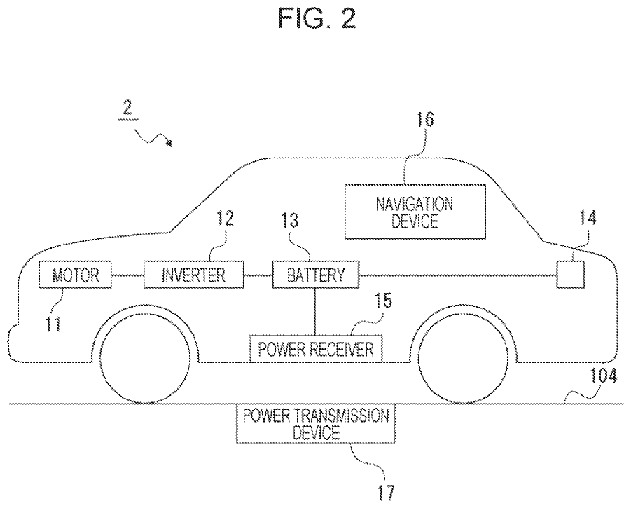

FIG. 2 is a diagram illustrating a configuration of the vehicle 2. As illustrated in FIG. 2, the vehicle 2 is an automobile including a motor 11, such as an electric vehicle or a hybrid vehicle. In addition to the motor 11, the vehicle 2 includes an inverter 12, a battery 13, a charging plug 14, a power receiver 15, and a navigation device 16.

The motor 11 is a power source that causes the vehicle 2 to travel, and is, for example, a three phase alternating current motor. The motor 11 generates a driving force by electric power supplied from the battery 13 via the inverter 12, and transmits the driving force to driving wheels to cause the vehicle 2 to travel. When the vehicle 2 is a hybrid vehicle, the vehicle 2 also includes an engine as a power source.

The motor 11 generates electricity (electric power) by performing a regenerative operation. The electricity generated by the regenerative operation of the motor 11 is supplied to the battery 13 via the inverter 12.

The inverter 12 converts a direct current supplied from the battery 13 into a three phase alternating current and supplies the alternating current to the motor 11. When the motor 11 performs the regenerative operation, the inverter 12 converts an alternating current supplied from the motor 11 into a direct current and supplies the direct current to the battery 13.

The battery 13 is a so-called high-voltage secondary battery and stores the electricity to be supplied to the motor 11. The battery 13 can be charged by the regenerative operation of the motor 11.

The battery 13 can also be charged with electricity supplied from an external charging device via a charging gun or the like inserted into the charging plug 14.

Furthermore, the power receiver 15 is provided in a lower portion of the vehicle 2. Electric power is supplied from a power transmission device 17 installed in a charging lane 104. The power receiver 15 receives the electric power in a contactless manner and supplies the received electricity to the battery 13. Thus, the battery 13 can be charged in a contactless manner. Note that an electromagnetic induction method, an electrolytic resonance method, a microwave method, or the like is employed as a contactless charging method.

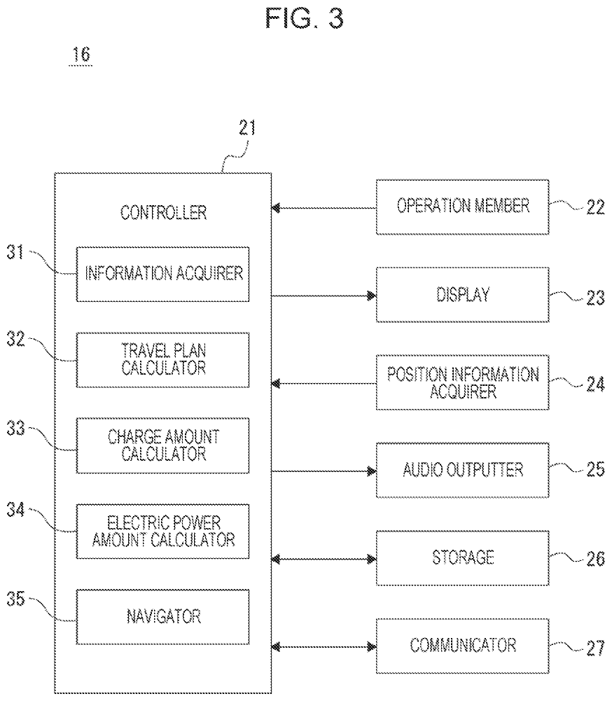

FIG. 3 is a diagram illustrating a configuration of the navigation device 16. As illustrated in FIG. 3, the navigation device 16 includes a controller 21, an operation member 22, a display 23, a position information acquirer 24, an audio outputter 25, a storage 26, and a communicator 27.

The controller 21 includes a computer such as an electronic control unit (ECU) and controls the entirety of the navigation device 16. The controller 21 serves as an information acquirer 31, a travel plan calculator 32, a charge amount calculator 33, an electric power amount calculator 34, and a navigator 35. These functional members will be described later.

The operation member 22 includes a button, a dial, a touch panel, and the like and receives a user operation. Upon receiving the user operation, the operation member 22 outputs a signal corresponding to the operation to the controller 21.

The display 23 is a liquid crystal display or an organic electroluminescent (EL) display and displays various images (screens) under the control of the controller 21.

The position information acquirer 24 includes a receiver that receives a global navigation satellite system (GNSS) signal. The position information acquirer 24 receives the GNSS signal from GNSS satellites and calculates the position (current position) of the vehicle 2, based on the received GNSS signal. The position information acquirer 24 may receive the GNSS signal, and the controller 21 may calculate the current position of the vehicle 2.

For example, the audio outputter 25 is a speaker and outputs various sounds (music, voice, and the like) under the control of the controller 21.

The storage 26 is a non-volatile memory such as a hard disk drive (HDD) or a flash memory and stores various kinds of information (for example, map data). The storage 26 may also store a program to be executed by the controller 21.

The communicator 27 communicates with the server 3 via the network 4.

For example, the controller 21 reads a map around the current position of the vehicle 2 from the map data stored in the storage 26 and displays the read map on the display 23 together with an icon indicating the current position of the vehicle 2. In addition, the controller 21 provides navigation of a route to the destination by using the display 23 or the audio outputter 25. The destination is set in advance by the user.

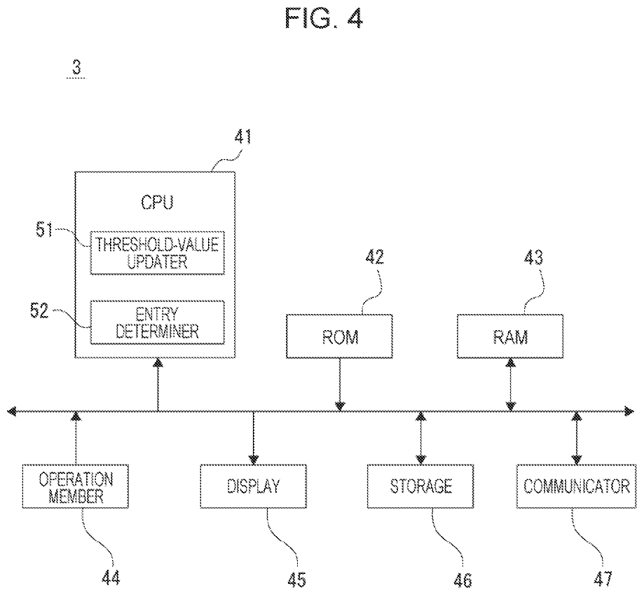

FIG. 4 is a diagram illustrating a configuration of the server 3. As illustrated in FIG. 4, the server 3 is a computer including a central processing unit (CPU) 41, a read only memory (ROM) 42, and a random access memory (RAM) 43.

The CPU 41 controls the entirety of the server 3 by executing a program stored in the ROM 42 or a program read from a storage 46 and loaded into the RAM 43. The CPU 41 serves as a threshold-value updater 51 and an entry determiner 52. These functional members will be described later.

In addition to the CPU 41, the ROM 42, and the RAM 43, the server 3 includes an operation member 44, a display 45, the storage 46, and a communicator 47.

The operation member 44 includes a keyboard, a mouse, a button, a dial, a touch panel, and the like and receives a user operation. Upon receiving the user operation, the operation member 44 outputs a signal corresponding to the operation to the CPU 41.

The display 45 is a liquid crystal display or an organic EL display and displays various images (screens) under the control of the CPU 41.

The storage 46 is a non-volatile memory such as an HDD or a flash memory and stores various kinds of information. The storage 46 may store a program to be executed by the CPU 41.

The communicator 47 communicates with the vehicle 2 (the navigation device 16) via the network 4.

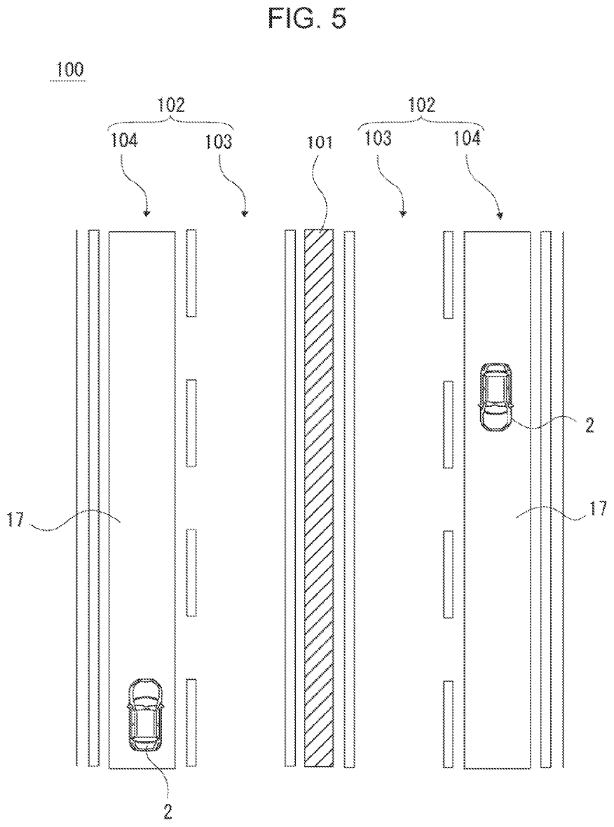

FIG. 5 is a diagram illustrating an example of a road 100 on which the vehicle 2 travels. As illustrated in FIG. 5, the road 100 on which the vehicle 2 travels is an expressway, for example. On the road 100, travel lanes 102 in which vehicles can travel in opposite directions are provided with a median strip 101 interposed therebetween. The example in FIG. 5 illustrates a case in which the two travel lanes 102 are provided in each direction.

Each of the travel lanes 102 is roughly divided into a normal lane 103 and the charging lane 104. The normal lane 103 is a lane in which the power transmission device 17 is not installed. The charging lane 104 is a lane in which the power transmission device 17 is installed and is the farthest lane from the median strip 101, for example. Note that the power transmission device 17 is not installed in the entire region of the travel lane 102, but is installed in a certain section. Therefore, the normal lanes 103 are coupled to the front and rear of the charging lane 104, respectively.

The number of travel lanes 102 is not limited to two and may be any number. In addition, the number of normal lanes 103 and the number of charging lanes 104 are not limited to one and may be any number.

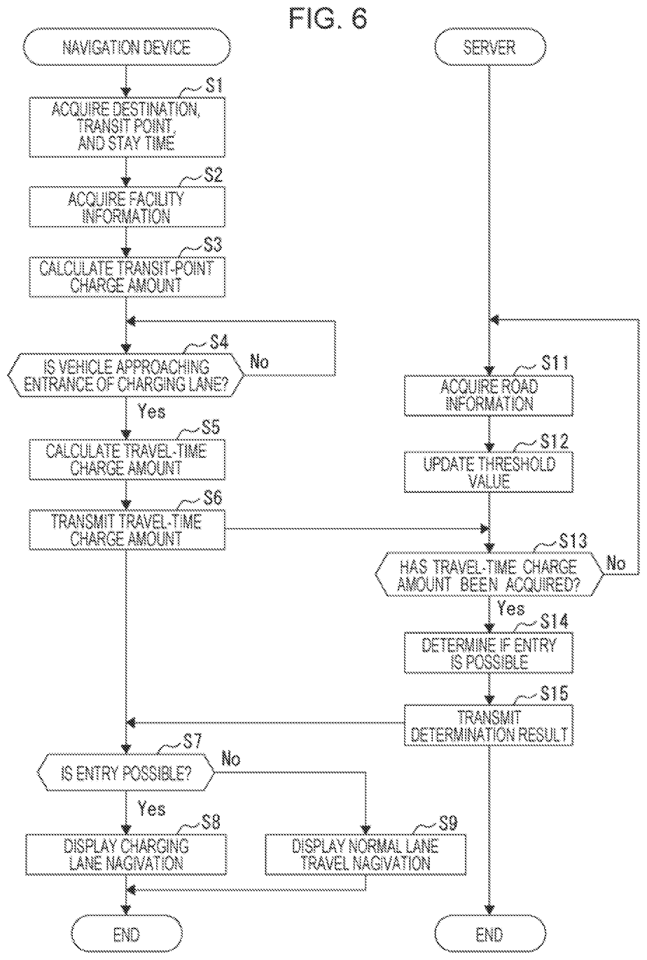

FIG. 6 is a sequence chart illustrating a flow of a charging lane navigation process in the charging system 1.

When a large number of vehicles 2 that can be charged in a contactless manner by using the power receiver 15 enter and travel in the charging lane 104, the charging lane 104 may be congested, and almost no vehicles 2 may travel in the normal lane 103. In addition, in such a case, there is a possibility that the vehicle 2 having an insufficient battery remaining amount to arrive at the destination is unable to enter the charging lane 104.

Therefore, the charging system 1 performs the charging lane navigation process in which the vehicle 2 that is to be charged in the charging lane 104 is preferentially navigated to the charging lane 104 to be charged.

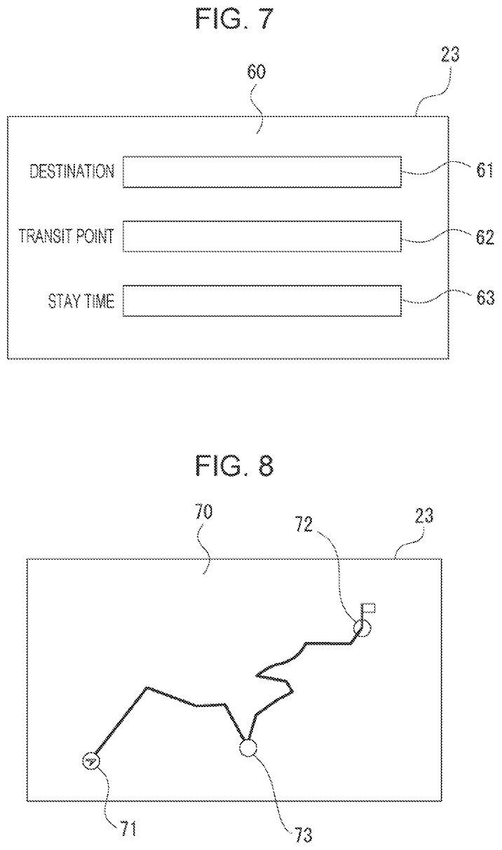

FIG. 7 is a diagram illustrating an input screen 60 for the destination, a transit point, and a stay time. FIG. 8 is a diagram illustrating a navigation screen 70.

The navigation device 16 can display, on the display 23, the input screen 60 for allowing the user to input the destination, the transit point, and the stay time as illustrated in FIG. 7.

The input screen 60 is provided with a destination input field 61 for inputting the destination, a transit point input field 62 for inputting the transit point, and a stay time input field 63 for inputting the stay time at the transit point.

The user inputs the destination, the transit point, and the stay time in the destination input field 61, the transit point input field 62, and the stay time input field 63 of the input screen 60, respectively, via the operation member 22. Thus, the information acquirer 31 acquires information on the destination, the transit point, and the stay time in step S1 illustrated in FIG. 6.

The information acquirer 31 may acquire the information on the destination, the transit point, and the stay time by a method other than the input via the input screen 60. For example, the information acquirer 31 may acquire the information from a smartphone or the like owned by the user via the communicator 27.

The stay time is a predicted time for which the user stays at the transit point, and the user does not necessarily stay at the transit point for the stay time.

Upon acquiring the information on the destination, the transit point, and the stay time, the travel plan calculator 32 calculates a route to the transit point and the destination. Subsequently, for example, as illustrated in FIG. 8, the controller 21 displays, on the display 23, the navigation screen 70 on which icons 71, 72, and 73 corresponding to the current position, the destination, and the transit point, respectively, are superimposed on the map. In addition, the controller 21 provides navigation to the route to the transit point and the destination, based on the current position of the vehicle 2 input from the position information acquirer 24 and the map data.

In step S2, the information acquirer 31 acquires facility information of the transit point acquired by the travel plan calculator 32 from the server 3 or another device. The facility information includes information on charging equipment, a congestion state, and weather.

The information on the charging equipment indicates the number of charging devices installed at the transit point, the charging capacity of the charging devices, and the like.

The congestion state indicates the usage state of the charging devices (how many charging devices are used), the degree of congestion at the transit point, and the like.

The weather indicates the weather of the transit point.

These pieces of facility information may be stored in the storage 26 of the server 3 or may be stored in another device via the network 4.

In step S3, the charge amount calculator 33 calculates the charge amount with which the battery 13 can be charged while the vehicle 2 is staying at the transit point, based on the acquired facility information and the stay time. As a method of calculating the charge amount, the following method is considered: a method of calculating a time during which the vehicle 2 can use the charging devices, based on the congestion state and the number of charging devices, and calculating the charge amount, based on the calculated time, the charging capacity of the charging devices, and the weather. At this time, the charge amount calculator 33 may calculate the charge amount, based on a map in which the calculated time, the charging capacity of the charging devices, and the weather are associated with each other, may calculate the charge amount by using a model obtained by machine learning in advance, or may calculate the charge amount by another method.

Hereinafter, the charge amount with which the battery 13 can be charged while the vehicle 2 is staying at the transit point will be referred to as a transit-point charge amount.

In step S4, the electric power amount calculator 34 determines whether the vehicle 2 is approaching the entrance of the charging lane 104, based on the map data and the current position of the vehicle 2. At this time, the map data may include position information of the charging lane 104.

Whether the vehicle 2 is approaching the entrance of the charging lane 104 may be determined by another method. For example, the navigation device 16 may transmit the current position of the vehicle 2 to the server 3, and the server 3 may determine whether the vehicle 2 is approaching the entrance of the charging lane 104, based on the map data, and then transmit the result to the navigation device 16. In addition, the vehicle 2 may receive information indicating that the vehicle 2 is approaching the entrance of the charging lane 104 from a communication device installed in the road 100 through communication.

When the vehicle 2 is approaching the entrance of the charging lane 104 (Yes in step S4), the electric power amount calculator 34 calculates the electric power amount for the vehicle 2 to arrive at the destination, for example, by dividing the remaining distance to the destination by the electric power consumption of the vehicle 2 (the motor 11).

In addition, the electric power amount calculator 34 subtracts the current remaining amount of the battery 13 from the electric power amount for the vehicle 2 to arrive at the destination to calculate a shortfall electric power amount for the vehicle 2 to arrive at the destination.

Hereinafter, the electric power amount for the vehicle 2 to arrive at the destination will be referred to as arrival electric power amount, the current remaining amount of the battery 13 will be referred to as battery remaining amount, and the shortfall electric power amount for the vehicle 2 to arrive at the destination will be referred to as shortfall electric power amount.

In addition, in step S5, the electric power amount calculator 34 calculates a charge amount at the charging lane 104 by subtracting the transit-point charge amount from the shortfall electric power amount. That is, the electric power amount calculator 34 subtracts the battery remaining amount and the transit-point charge amount from the arrival electric power amount to calculate the charge amount at the charging lane 104.

Hereinafter, the charge amount at the charging lane 104 will be referred to as a travel-time charge amount.

For example, when the arrival electric power amount is 100 kWh and the battery remaining amount is 30 kWh, the shortfall electric power amount is 70 kWh. When the transit-point charge amount is 40 kWh, the travel-time charge amount is 30 kWh.

Note that, for example, when the arrival electric power amount is small or the battery remaining amount is large, the shortfall electric power amount or the travel-time charge amount may be negative (the vehicle 2 can arrive at the destination without being charged at the charging lane 104).

Upon calculating the travel-time charge amount in this manner, in step S6, the electric power amount calculator 34 transmits the calculated travel-time charge amount to the server 3.

On the other hand, in step S11, the threshold-value updater 51 of the server 3 acquires road information. The road information includes the total number of vehicles 2 traveling in the travel lane 102 (the total number of vehicles) and the number of vehicles 2 traveling in the charging lane 104 (the number of vehicles that are being charged).

For example, when the road 100 is an expressway, the total number of vehicles can be calculated from the number of vehicles 2 that have entered the expressway.

The number of vehicles that are being charged can be calculated from the number of vehicles 2 that are being charged by the power transmission device 17.

In step S12, the threshold-value updater 51 updates the threshold value, based on the total number of vehicles and the number of vehicles that are being charged. Here, the threshold value is a value used for comparison with the travel-time charge amount in order to determine whether to navigate the vehicle 2 to the charging lane 104. The larger the threshold value, the more difficult it is to navigate the vehicle 2 to the charging lane 104, and the smaller the threshold value, the easier it is to navigate the vehicle 2 to the charging lane 104.

The threshold-value updater 51 calculates the number of vehicles 2 traveling in the normal lane 103 by subtracting the number of vehicles that are being charged from the total number of vehicles. The threshold-value updater 51 also updates the threshold value, based on the ratio between the number of vehicles 2 traveling in the normal lane 103 and the number of vehicles 2 traveling in the charging lane 104. For example, the threshold-value updater 51 lowers the threshold value when the ratio of the vehicles 2 traveling in the normal lane 103 is high, and raises the threshold value when the ratio of the vehicles 2 traveling in the charging lane 104 is high.

In step S13, the entry determiner 52 determines whether the travel-time charge amount has been received from the vehicle 2. When the travel-time charge amount has not been received (No in step S13), step S11 and step S12 are repeatedly performed at predetermined intervals until the travel-time charge amount is received.

This makes it possible to perform entry determination (step S14), which will be described later, using the threshold value corresponding to the state of the road 100 at the time of reception of the travel-time charge amount.

When the travel-time charge amount has been received (Yes in step S13), in step S14, the entry determiner 52 determines whether the entry into the charging lane 104 is possible, based on the travel-time charge amount and the threshold value updated in step S12. Here, the entry determiner 52 determines that the entry is possible when the travel-time charge amount is greater than or equal to the threshold value. On the other hand, the entry determiner 52 determines that the entry is not possible when the travel-time charge amount is less than the threshold value.

In step S15, the entry determiner 52 transmits the determination result in step S14 to the vehicle 2.

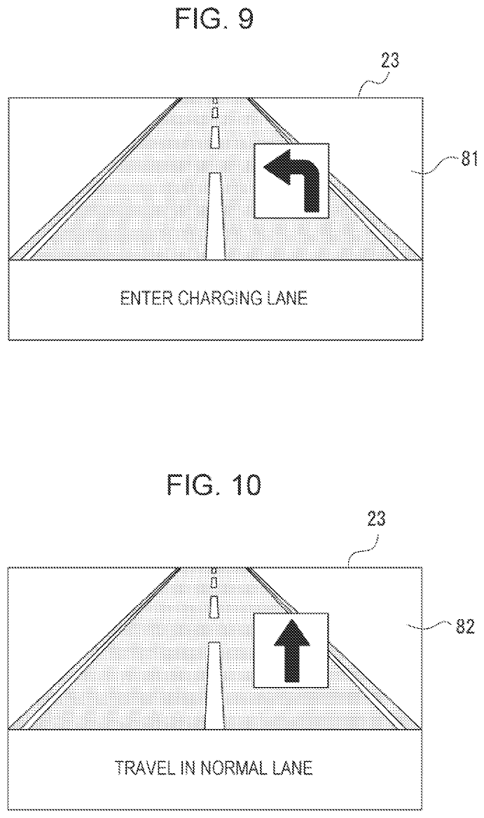

FIG. 9 is a diagram illustrating a charging lane entry navigation screen 81. FIG. 10 is a diagram illustrating a normal lane travel navigation screen 82.

In the vehicle 2, upon receiving the determination result, in step S7, the navigator 35 determines whether the entry into the charging lane 104 is possible, based on the determination result. As a result, when the entry into the charging lane 104 is possible (Yes in step S7), in step S8, the navigator 35 causes the display 23 to display the charging lane entry navigation screen 81 for navigating the vehicle 2 to enter the charging lane 104, as illustrated in FIG. 9.

On the other hand, when the entry into the charging lane 104 is not possible (No in step S7), in step S9, the navigator 35 causes the display 23 to display the normal lane travel navigation screen 82 for letting the vehicle 2 travel in the normal lane 103, that is, for not navigating the vehicle 2 to enter the charging lane 104, as illustrated in FIG. 10.

As described above, in the charging system 1, when the vehicle 2 is to stay at the transit point, it is determined whether the entry into the charging lane 104 is possible in consideration of the charge amount at the transit point, and the vehicle 2 is navigated to enter the charging lane 104 or to travel in the normal lane 103.

Accordingly, it is possible to reduce a situation in which the vehicles 2 are concentrated on one of the normal lane 103 and the charging lane 104 and a congestion is likely to occur, and to charge the battery 13 by preferentially causing the vehicle 2 that is likely to be charged in the charging lane 104 to travel in the charging lane 104.

Although the embodiment according to the present disclosure has been described above, the present disclosure is not limited to the above-described specific examples, and can adopt various configurations.

For example, in the above-described embodiment, the functional members of the information acquirer 31, the travel plan calculator 32, the charge amount calculator 33, the electric power amount calculator 34, and the navigator 35 are provided in the navigation device 16 (the controller 21). However, some or all of the functional members of the information acquirer 31, the travel plan calculator 32, the charge amount calculator 33, the electric power amount calculator 34, and the navigator 35 may be provided in the server 3 (the CPU 41).

In the above-described embodiment, the functional members of the threshold-value updater 51 and the entry determiner 52 are provided in the server 3 (the CPU 41). However, the respective functional members of the threshold-value updater 51 and the entry determiner 52 may be provided in the navigation device 16 (the controller 21).

In the above-described embodiment, navigation of the entry into the charging lane 104 or travel in the normal lane 103 is provided by displaying the charging lane entry navigation screen 81 or the normal lane travel navigation screen 82 on the display 23. However, the navigator 35 may provide the navigation of the entry into the charging lane 104 or travel in the normal lane 103 by voice, or may provide the navigation by both screen display and voice.

In addition, in the above-described embodiment, the stay time is input by the user, but an average stay time at the transit point may be acquired as the stay time.

In the above-described embodiment, the facility information includes the information on charging equipment, the congestion state of the charging equipment, and the information on the weather at the transit point. However, the facility information may not include some of these pieces of information or may include other information as long as the transit-point charge amount can be calculated.

As described above, the charging system 1 of the embodiment includes the vehicle 2 and the server 3. The vehicle 2 includes the battery 13 that is chargeable in a contactless manner from the power transmission device 17 installed in the road 100, and the server 3 is capable of communicating with the vehicle 2. The charging system 1 further includes the information acquirer 31, the electric power amount calculator 34, the charge amount calculator 33, the entry determiner 52, and the navigator 35. The information acquirer 31 acquires the information on the destination, the transit point, and the stay time at the transit point. The electric power amount calculator 34 calculates the electric power amount (arrival electric power amount) for the vehicle 2 to arrive at the destination. The charge amount calculator 33 calculates the charge amount (transit-point charge amount) with which the battery 13 is chargeable at the transit point, based on the facility information of the transit point. The entry determiner 52 determines whether the entry into the charging lane 104 in which the power transmission device 17 is installed is possible, based on the electric power amount and the charge amount. The navigator 35 navigates the vehicle 2 to enter the charging lane 104 when the entry determiner 52 determines that the entry into the charging lane 104 is possible.

As a result, the charging system 1 calculates the shortfall electric power amount of the battery 13 for the vehicle 2 to arrive at the destination in consideration of the charge amount at the transit point. Accordingly, the charging system 1 can more accurately determine the vehicle 2 that is to be charged in the charging lane 104.

In this manner, in the charging system 1, it is possible to navigate, to the charging lane 104, the vehicle 2 that is likely to be charged while reducing congestion in the charging lane 104.

The entry determiner 52 determines that the entry into the charging lane 104 is possible when the value obtained by subtracting the remaining amount (battery remaining amount) of the battery 13 and the charge amount (transit-point charge amount) from the electric power amount (arrival electric power amount) is greater than or equal to the threshold value.

Accordingly, since the threshold value can be changed in accordance with the situation of the road 100, the vehicle 2 can be optimally navigated to the charging lane 104 in accordance with the situation of the road 100, and the congestion can be further reduced.

The charging system 1 further includes the threshold-value updater 51 that updates the threshold value, based on the total number of vehicles traveling on the road 100 including the charging lane 104 and the number of vehicles traveling in the charging lane 104.

Accordingly, in the charging system 1, it is possible to change the threshold value according to the ratio of the vehicles 2 traveling in the normal lane 103 and the charging lane 104. Therefore, in the charging system 1, it is possible to navigate, to the charging lane 104, the vehicle 2 that is likely to be charged while further reducing the congestion.

The threshold-value updater 51 updates the threshold value at predetermined time intervals.

Accordingly, in the charging system 1, it is possible to determine whether the vehicle 2 can enter the charging lane 104 using the threshold value when the vehicle 2 approaches the entrance of the charging lane 104.

Therefore, the charging system 1 can accurately determine whether the entry into the charging lane 104 is possible.

The facility information includes the information on the charging equipment, the congestion state of the charging equipment, and the information on the weather at the transit point.

Accordingly, the charging system 1 can accurately calculate the charge amount at the transit point.

According to the present disclosure, it is possible to navigate, to the charging lane, the vehicle that is likely to be charged while reducing congestion in the charging lane.

The information acquirer 31, the electric power amount calculator 34, the charge amount calculator 33, the entry determiner 52, and the navigator 35 illustrated in FIG. 3 and FIG. 4 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of The information acquirer 31, the electric power amount calculator 34, the charge amount calculator 33, the entry determiner 52, and the navigator 35. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 3 and FIG. 4.

1. A charging system comprising a vehicle and a server, the vehicle comprising a battery that is configured to be charged in a contactless manner from a power transmission device installed in a road, the server being configured to communicate with the vehicle, the charging system comprising:
an information acquirer configured to acquire information on a destination, a transit point, and a stay time at the transit point of the vehicle;
an electric power amount calculator configured to calculate an electric power amount for the vehicle to arrive at the destination;
a charge amount calculator configured to calculate a charge amount with which the battery is chargeable at the transit point, based on facility information of the transit point;
an entry determiner configured to determine whether entry into a charging lane in which the power transmission device is installed is possible, based on the electric power amount and the charge amount; and
a navigator configured to navigate the vehicle to enter the charging lane when the entry determiner determines that the entry into the charging lane is possible.

2. The charging system according to claim 1, wherein
the entry determiner is configured to, when a value obtained by subtracting a remaining amount of the battery and the charge amount from the electric power amount is greater than or equal to a threshold value, determine that the entry into the charging lane is possible.

3. The charging system according to claim 2, further comprising:
a threshold-value updater configured to update the threshold value, based on a total number of vehicles traveling on a road including the charging lane and a number of vehicles traveling in the charging lane.

4. The charging system according to claim 3, wherein
the threshold-value updater is configured to
update the threshold value at predetermined time intervals.

5. The charging system according to claim 1, wherein
the facility information comprises information on charging equipment, a congestion state of the charging equipment, and information on weather at the transit point.

6. A charging system comprising a vehicle and a server, the vehicle comprising a battery that is configured to be charged in a contactless manner from a power transmission device installed in a road, the server being configured to communicate with the vehicle, the charging system comprising
circuitry configured to
acquire information on a destination, a transit point, and a stay time at the transit point of the vehicle,
calculate an electric power amount for the vehicle to arrive at the destination,
calculate a charge amount with which the battery is chargeable at the transit point, based on facility information of the transit point,
determine whether entry into a charging lane in which the power transmission device is installed is possible, based on the electric power amount and the charge amount, and
navigate the vehicle to enter the charging lane when the entry into the charging lane is determined to be possible.
